(19) United States
(12) Patent Application Publication
(10) Pub. No.: US 2013/0273821 A1
(43) Pub. Date: Oct. 17, 2013

(54) SYSTEM AND A METHOD FOR INCREASING SAFETY OF USERS OF MACHINING, MANUFACTURING AND PRODUCING TOOLS

(71) Applicant: Pouyan PIRDIR, Rasht (IR)

(72) Inventor: Pouyan PIRDIR, Rasht (IR)

(21) Appl. No.: 13/660,660

(22) Filed: Oct. 25, 2012

Related U.S. Application Data
(60) Provisional application No. 61/551,186, filed on Oct. 25, 2011.

(51) Int. Cl. B23Q 11/00

(52) U.S. Cl. CPC B23Q 11/0064
USPC 451/453

(57) ABSTRACT

The invention relates to a system for angle grinders or any kind of stable or power hand tool cutting and grinding machines which produce or scatter filings. This system including a guard and/or an absorbing device can use of any kind of permanent and/or non-permanent electric and/or magnetic fields to absorb, collect and storage the filings scattered, suspended and produced by the machines and won't let them to damage and hurt the user's eyes and/or body and/or cloth and prevent scattering filings in the air and environment. In addition it provides the possibility for re-using of filings in any and different applications and also the possibility of using any kind of cutting and grinding machines inside non-workshops, dangerous and flammable places like houses, accident scenes and so on.

Using Grinding and cutting machines same as angle grinders and the like is very common in shaping metals.

Using these machines tools produce a lot of filings or swarf which are very dangerous for users because of their hit and speed so they cause lots of problems and limitations for using these machines.

Users have to wear glasses while working with these machines and some other ways are introduced to protect users but none of them are safe enough.

Also it is not possible to use these machines in none-workshops places.

The present invention relates to a new system using a new guard and/or a new device which can prevent these machines to scatter filings.

Using the device of this system, it is possible to use grinding and/or cutting machines inside none-workshop places like hoses and so on.

Using this system, cutting and grinding machine's users are safe.

Using this system, eyes of users are protected as well.

Using this system, body and cloth of users are protected as well.

Not only users are in danger, But also facilities, tender installations and the like around the environment are in danger too.

Workers always have problems with the filings scattered around their workshops.

Using this system, the environment can be safe and clean.

Using this system, it's possible to use the filings again.

### FIGURES

FIG. 1 describes the guard of this system which contains:
1a: A railing system for the plate (2a) to move that way for making a distance between stored filings and the magnetic core.
2a: A plate shaped as shown by any kind of metals that can hold a core of any kind of magnetic or electric fields materials.
3a: core of the system's guard that can contain any kind of materials or metals that have permanent and/or none-permanent magnetic and/or electric fields. This core can absorb filings produced behind part 4a.
4a: a plate as shown made by any kind of metals and/or materials which magnetic and/or electric fields can pass and absorb filings produces and scattered while using those machines so that hunted filings cannot damage the surface of the plate and guard.
This system can be used instead of common guards of all kind of cutting and grinding tools and machines. It would absorb filings produced by the metal and prevent them to scatter in the environment so we have safety for the user and the environment.

FIG. 2 describes the device of system, suitable for stable tools and machines.
1b: the clamp with the possibility of setting on any kind of tools, tables, devices and the kind around the working place and the machine.
2b: a flexible stand made by any kind of materials like flexible metallic pipes and the kind using to hold the device in any directions that the user want.
3b: a conical plate as shown made by any kind of materials that any kind of magnetic or electric fields can pass and absorb the filings or swarfs produced and scattered by tools and machines.
4b: a plate that holds and separates the materials that can make magnetic or electric fields.
5b: A storage pipe for storing the filings absorbed by the system.
6b: a gap between the materials that make magnetics and/or electric fields.
7b: the materials that make magnetics and/or electric fields.
This system is used to absorb all the filings, specially used for stable cutting and grinding machines and tools. It can absorb the filings scattered in any direction and the user can easily set it into any direction that he/she wants.

FIG. 3 describes how this system can be used instead of the common guard of angle grinders and the kind. This system can protect the user.
FIG. 3 contains:
5a: the system instead of common guard made by materials mentioned in FIG. 1.
6a: a handle to make a distance between plate 1a and 3a to pour and empty the absorbed filings.

FIG. 4 describes the device of the system suitable for some tools and machines which contains:
9b: the clamp with the possibility of setting on any kind of tools, tables, devices and the kind around the working place and the machine. As in (1b—FIG. 2)
10b: a stand made by a flexible pipe or material and so on to make the possibility for absorbing in any direction required by users. As in (2b—FIG. 2)
11b: a conical plate as shown made by any kind of materials that any kind of magnetic or electric fields can pass and absorb the filings or swarfs produced and scattered by tools and machines. As in (3b—FIG. 2)
12b: A storage pipe for storing the filings absorbed by the system. As in (5b—FIG. 2)

FIG. 5 describes how the emptying system works. It contains:
7a: a handle to make a distance between plate 3a—FIG. 1 and the core.
8a: a railing system for the plate's movement.
This system lets the absorbed filings pour and re-using them is possible now.

FIG. 6 describes how the whole system with its guard would help increasing the safety of the workers.
It contains:
9a: a worker using system's special guard.

Machining, Manufacturing and producing tools like cutting and grinding machines and so on are now used worldwide. They all have the problem of scattering and producing filings. They have introduced lots of ways for safety but they weren't successful enough. They can't prevent scattering filings around so it is very dangerous for workers and users around. It causes them damage on their corneas because of external objects and even some of them unfortunately become blind. Also the problem doesn't end with individual dangers. The user of cutting and grinding machines usually should do his/her job in a safe place alone to prevent these dangers for others. So it can slow down a project if others should work too. Current safety devices can't solve this problem. Current safety systems and devices are not able to prevent the machine to scatter filings around. By using this system the safety insurance rate would decrease because the risk of danger would decrease using this system for workers.

FIGS. 1 to 6 attempt to clearly show a system for angle grinders or any kind of stable or power hand tool cutting and grinding machines that produce or scatter filings. This system including a guard and/or an absorbing device can use of any kind of permanent and/or non-permanent electric and/or magnetic fields to absorb, collect and storage the filings scattered, suspended and produced by the machines and won't let them to damage and hurt the user's eyes and/or body and/or cloth and prevent scattering filings in the air and environment. In addition it provides the possibility for re-using of filings in any and different applications and also the possibility of using any kind of cutting and grinding machines inside non-workshops, dangerous and flammable places like houses, accident scenes and so on.

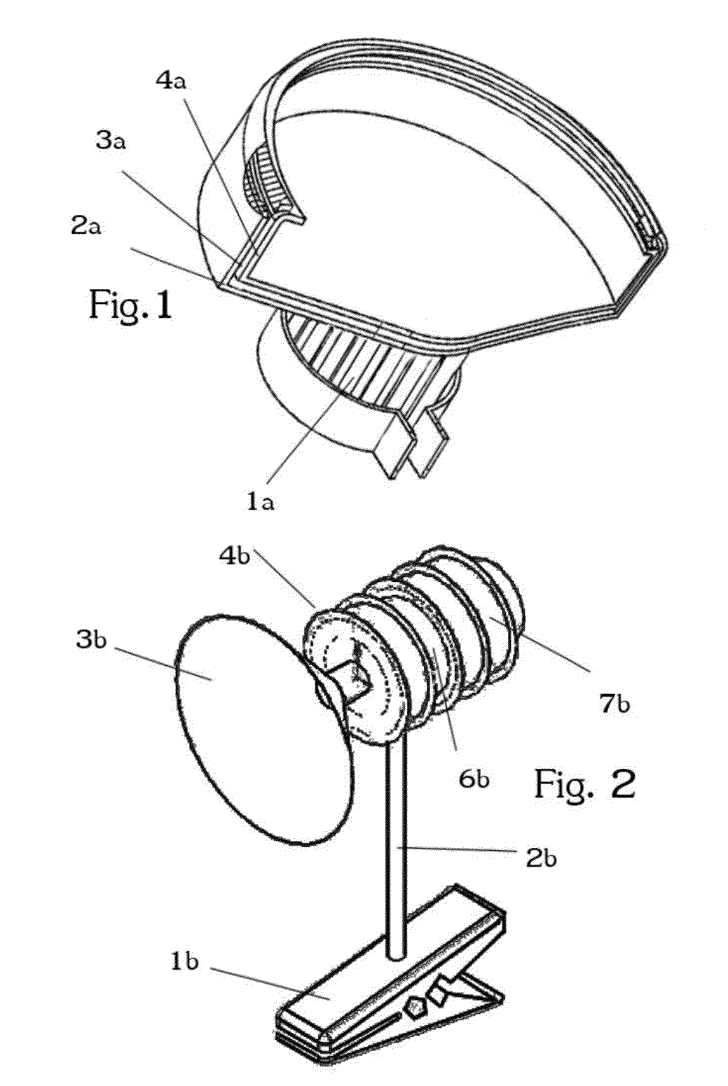

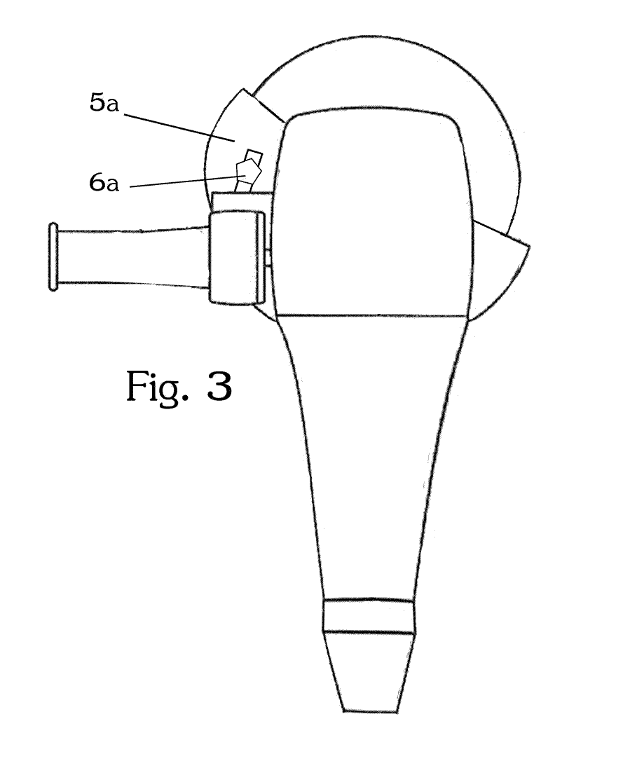

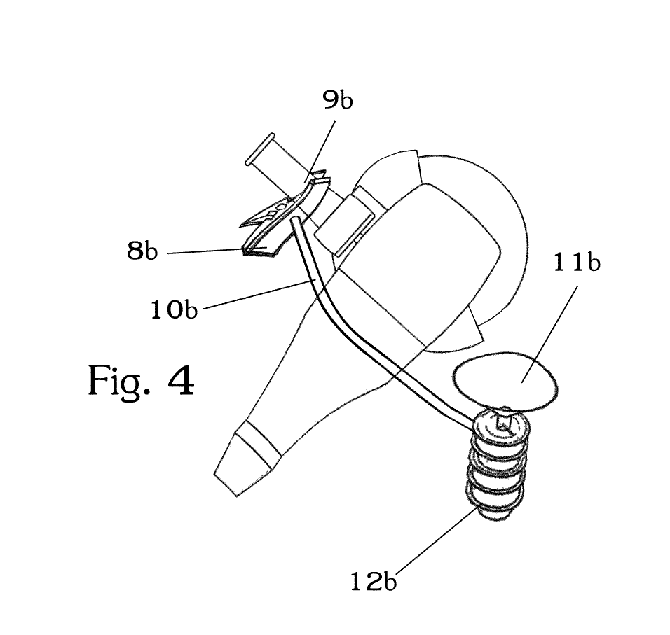

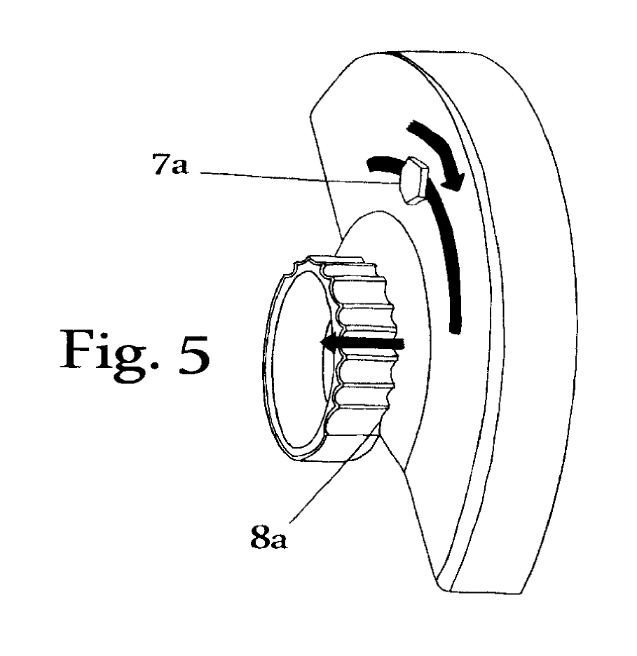

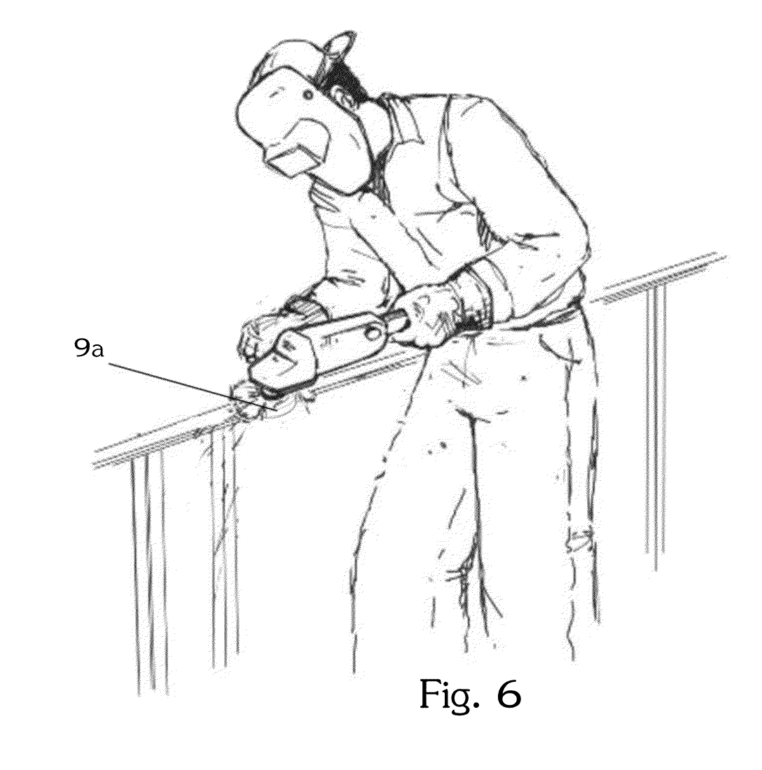

1. A system (Filings Absorber) which its parts can be made of different types of metals and/or carbon and/or natural or artificial fibers and/or paper and/or asbestos and/or nanomaterials and/or leather and/or wood and/or composite and/or glass and/or etc and/or a combination of what herebefore mentioned.

2. A system (Filings Absorber) which according to claim 1 may be designed and made in various sizes and/or dimensions and forms.

3. A system (Filings Absorber) which according to claim 1 may contain one and/or some movable and/or portable parts around the filings producer machine.

4. A system (Filings Absorber) which according to claim 1 can be used for Automatic and/or Manual Machining, Manufacturing, Producing, Cutting and Grinding Hand tools and/or Automatic and/or Manual stable Machining, Manufacturing, Producing, Cutting and Grinding Tools.

5. A System (Filings Absorber) according to claim 1 can use of AC and/or DC and/or a combination of them.

6. A System (Filings Absorber) according to claim 1 may contain permanent and/or non-permanent magnetic fields and/or magnets, and/or permanent and/or non-permanent electrical fields and/or magnets.
